(19) United States
(12) Patent Application Publication
(10) Pub. No.: US 2024/0117190 A1
(43) Pub. Date: Apr. 11, 2024

(54) LIGHT ABSORBING AGENT, COMPOSITION, OPTICAL MEMBER, AND METHOD OF MANUFACTURING LIGHT ABSORBING AGENT

(71) Applicant: THE JAPAN STEEL WORKS, LTD., Tokyo (JP)

(72) Inventors: Keisuke WASHIO, Tokyo (JP); Ryo YAMAWAKI, Tokyo (JP)

(21) Appl. No.: 18/237,113

(22) Filed: Aug. 23, 2023

(30) Foreign Application Priority Data
Sep. 16, 2022 (JP) 2022-147963

(51) Int. Cl. C09B 57/00; C07F 9/11; C07F 9/12; C07F 9/30; C07F 9/38; C08K 5/523; C08K 5/5357

(52) U.S. Cl. CPC C09B 57/00; C07F 9/11; C07F 9/12; C07F 9/304; C07F 9/3808; C07F 9/3882; C07F 9/3891; C08K 5/523; C08K 5/5357; G02B 5/208

(57) ABSTRACT

Provided is a light absorbing agent that excels in miscibility with a resin, a method of manufacturing such a light absorbing agent, a composition that excels in dispersiveness of such a light absorbing agent, and an optical member that excels in visible light transmitting performance and near-infrared radiation blocking performance. The light absorbing agent contains a compound expressed by Formula (1) below and a copper ion.

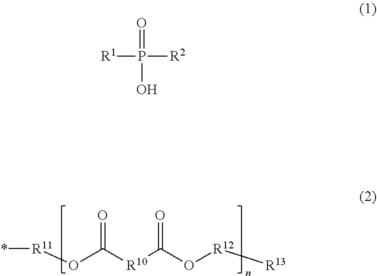

In the above, R¹ is a group expressed by Formula (2) above, R¹⁰ is an alkylene group or arylene group that may have a substituent, R¹² is an alkylene group or arylene group that may have a substituent, and the other symbols are as described in the specification.

### INCORPORATION BY REFERENCE

This application is based upon and claims the benefit of priority from Japanese patent application No. 2022-147963, filed on Sep. 16, 2022, the disclosure of which is incorporated herein in its entirety by reference.

### BACKGROUND

The present disclosure relates to light absorbing agents, compositions, optical members, and methods of manufacturing light absorbing agents.

Digital cameras, for example, use image sensors, such as CCDs or CMOSs. As these image sensors are sensitive to near-infrared radiation, a film that absorbs near-infrared radiation is disposed on a light receiving surface of such an image sensor to block near-infrared radiation.

Known examples of films that absorb near-infrared radiation include a film in which a near-infrared radiation absorbing agent is dispersed in a resin.

For example, Japanese Unexamined Patent Application Publication No. 2011-99038 discloses a near-infrared radiation absorbing agent that contains a particular phosphonic acid compound, a particular phosphate compound, and copper ions, and also discloses a particular optical material that contains such a near-infrared radiation absorbing agent.

Meanwhile, International Patent Publication No. WO2019/93076 discloses a particular light absorbing composition that contains an alkoxysilane monomer and a light absorbing agent composed of a particular phosphonic acid and copper ions.

### SUMMARY

A light absorbing agent that contains copper ions and a phosphonic acid has a limit in terms of the resins that the agent can be used with, from the standpoint of their miscibility. If the miscibility of a light absorbing agent and a resin is insufficient, this may cause a film to have a low visible light transmittance.

The present disclosure has been made in view of such circumstances and is directed to providing a light absorbing agent that excels in miscibility with a resin, a method of manufacturing such a light absorbing agent, a composition that excels in dispersiveness of such a light absorbing agent, and an optical member that excels in visible light transmitting performance and near-infrared radiation blocking performance.

A light absorbing agent according to one aspect of the present disclosure comprising a compound expressed by Formula (1) below and a copper ion.

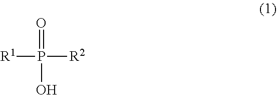

wherein
R¹ is a group expressed by Formula (2) below,
R² is a hydroxyl group, —R³, —Ar¹, —OR³, —OAr¹, —OR⁴—Ar¹, —OCOR³, —OCOAr¹, —R⁴—N(R⁵)₂, or —R¹,
R³ is an alkyl group that may have a substituent,
Ar¹ is an aryl group that may have a substituent,
R⁴ is an alkylene group that may have a substituent,
R⁵ is a hydrogen atom or an alkyl group that may have a substituent,

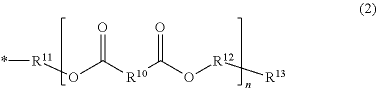

R¹⁰ is an alkylene group or arylene group that may have a substituent,
R¹¹ is a single bond or an alkylene group that may have a substituent,
R¹² is an alkylene group or arylene group that may have a substituent, wherein R¹² that bonds to R¹³ is a single bond,
R¹³ is a hydrogen atom or —R¹⁴ or —R¹⁵OH,
R¹⁴ is an alkyl group that may have a substituent,
R¹⁵ is a single bond or an alkylene group that may have a substituent,
n is an integer no smaller than 1,
* is a bond that bonds to P, and
if a formula includes multiple identical symbols, the multiple identical symbols may be groups identical to or different from each other.

The present disclosure can provide a light absorbing agent that excels in miscibility with a resin, a method of manufacturing such a light absorbing agent, a composition that excels in dispersiveness of such a light absorbing agent, and an optical member that excels in visible light transmitting performance and near-infrared radiation blocking performance.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 shows a transmittance spectrum of Example 1.

### DESCRIPTION OF EMBODIMENTS

Hereinafter, a light absorbing agent, a method of manufacturing a light absorbing agent, a composition, and an optical member, according to the present disclosure, will be described in sequence.

In the present disclosure, a compound expressed by Formula (1) may be referred to as “Compound (1).” Likewise, a group expressed by Formula (2) may be referred to as “Group (2).” This notation convention applies also to other compounds and so forth.

Unless specifically indicated otherwise, the symbol “—” indicating a numerical range means that the range includes the numerical values preceding and following the symbol as its lower and upper limits.

### [Light Absorbing Agent]

A light absorbing agent of the present disclosure contains a compound expressed by Formula (1) below and a copper ion.

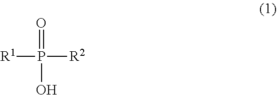

In the above,
R¹ is a group expressed by Formula (2) below,
R² is a hydroxyl group, —R³, —Ar¹, —OR³, —OAr¹, —OR⁴—Ar¹, —OCOR³, —OCOAr¹, —R⁴—N(R⁵)₂, or —R¹,
R³ is an alkyl group that may have a substituent,
Ar¹ is an aryl group that may have a substituent,
R⁴ is an alkylene group that may have a substituent,
R⁵ is a hydrogen atom or an alkyl group that may have a substituent,

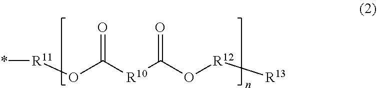

R¹⁰ is an alkylene group that may have a substituent, an arylene group that may have a substituent, or a group constituted by a combination thereof,
R¹¹ is a single bond or an alkylene group that may have a substituent,
R¹² is an alkylene group that may have a substituent, an arylene group that may have a substituent, or a group constituted by a combination thereof, but R¹² that bonds to R¹³ is a single bond,
R¹³ is a hydrogen atom or —R¹⁴ or —R¹⁵OH,
R¹⁴ is an alkyl group that may have a substituent,
R¹⁵ is a single bond or an alkylene group that may have a substituent,
n is an integer no smaller than 1,
* is a bond that bonds to P, and
if a formula includes multiple identical symbols, such multiple identical symbols may be groups identical to or different from each other.

Compound (1) above has a structure in which one or two groups that include a polyester structure expressed by Formula (2) bond to a phosphorus atom. It is estimated that the light absorbing agent of the present disclosure is present as a complex in which Compound (1) is coordinated to a copper ion. Therefore, in the light absorbing agent of the present disclosure, Group (2) is readily disposed outside the copper ion. As a result, the present light absorbing agent is estimated to have remarkably improved miscibility with various resins.

The light absorbing agent of the present disclosure contains at least Compound (1) and a copper ion and may further contain other compounds and so forth within a range in which advantageous effects of the present disclosure can be obtained. Each component will be described below.

### <Compound (1)>

R¹ in Formula (1) is Group (2).
R¹¹ in Group (2) is a single bond or an alkylene group that may have a substituent. If R¹¹ is a single bond, an O atom bonds to a P atom in Formula (1).

If R¹¹ is an alkylene group, a C atom in R¹¹ bonds to a P atom in Formula (1).

From the standpoint of miscibility with a resin or of the ease of synthesis, the alkylene group of R¹¹ is a linear alkylene group preferably of a carbon number 1-12, more preferably of a carbon number 1-6, or even more preferably of a carbon number 1-3. Specific examples of the alkylene group include a methylene group, an ethylene group, a propylene group, a butylene group, and a hexylene group. This alkylene group may have a hydrogen atom substituted. Examples of the substituent include an alkyl group of a carbon number 1-6, a halogen atom, and a hydroxyl group. The alkyl group in the substituent may be linear or branched. Specific Examples of such an alkyl group include a methyl group, an ethyl group, a propyl group, an n-butyl group, and a tert-butyl group, and a hydrogen atom may be substituted by a halogen atom or a hydroxyl group.

Examples of the halogen atom include F, Cl, Br, and I.

R¹⁰ and R¹² are each independently an alkylene group that may have a substituent, an arylene group that may have a substituent, or a group constituted by a combination thereof.

Examples of the alkylene group that may have a substituent include those similar to the examples listed for R¹¹ above.

In the arylene group that may have a substituent, the arylene group is a residue obtained by removing two hydrogen atoms from a monocyclic aromatic hydrocarbon or a polycyclic aromatic hydrocarbon of two to six rings. From the standpoint of improving visible light transmittance, the arylene group is preferably a monocyclic aromatic hydrocarbon or a polycyclic aromatic hydrocarbon of two or three rings or more preferably a phenylene group or a naphthylene group. There is no particular limitation on the positions of the hydrogen atoms to be removed (positions where esters bond) in the arylene group. In the case of a phenylene group, such a position may be any of the ortho position, the meta position, or the para position, but the para position is preferable from the standpoint of availability of the source material or stability of the compound. In the case of a naphthylene group, the 2,6 position, the 1,5 position, the 1,4 position, the 2,3 position, or the 2,7 position is preferable from the standpoint of a stable pose of the compound.

The arylene group may further have a hydrogen atom substituted. Examples of the substituent include an alkyl group of a carbon number 1-6, a halogen atom, and a hydroxyl group, and specific examples include those similar to the substituents listed for R¹¹ above.

Examples of the group constituted by a combination of an alkylene group that may have a substituent and an arylene group that may have a substituent include a structure such as *-alkylene group-arylene group-*, *-arylene group-alkylene group-arylene group, or *-alkylene group-arylene group-alkylene group-*, and specific examples include a group expressed by Formula (A1) or Formula (A2) below. In the above, * is a bond that bonds to an ester.

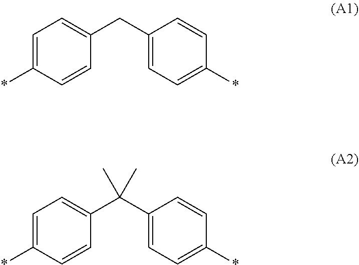 [SMILES: *c1ccc(Cc2ccc(*)cc2)cc1 ; *c1ccc(C(C)(C)c2ccc(*)cc2)cc1]

From the standpoint of improving miscibility with a resin, R¹⁰ is preferably an arylene group or a group constituted by a combination of an alkylene group and an arylene group, or more preferably an arylene group.

From the standpoint of improving miscibility by adding flexibility to Group (2), R¹² is preferably an alkylene group or a group constituted by a combination of an alkylene group and an arylene group, or more preferably an alkylene group.

R¹³ represents a terminal of Group (2) and is a hydrogen atom or —R¹⁴ or R¹⁵OH. R¹⁴ is an alkyl group that may have a substituent, and R¹⁵ is a single bond or an alkylene group that may have a substituent.

From the standpoint of miscibility with a resin or of the ease of synthesis, the alkyl group of R¹⁴ is a linear or branched alkylene group preferably of a carbon number 1-12, more preferably of a carbon number 1-6, or even more preferably of a carbon number 1-3. Specific examples of the alkyl group include a methyl group, an ethyl group, a propyl group, an n-butyl group, a tert-butyl group, and a hexyl group. This alkylene group may have a hydrogen atom substituted. Examples of the substituent include a halogen atom and a hydroxyl group.

Examples of the alkylene group that may have a substituent of R¹⁵ include those similar to the examples listed for R¹¹ above.

In Formula (2), n is a repeating unit. It suffices that n be no smaller than 1, and n may be adjusted as appropriate in accordance with the resin and so forth to be combined with. From the standpoint of infrared radiation absorbing performance of the light absorbing agent, n is preferably no greater than 30, more preferably no greater than 20, and even more preferably no greater than 15. From the standpoint of miscibility with a resin, it suffices that n be no smaller than 1, and sufficient miscibility can be observed even when n is 1.

The (partial) molecular weight of Group (2) may be adjusted as appropriate in accordance with the resin and so forth to be combined with. From the standpoint of infrared radiation absorbing performance of the light absorbing agent, the molecular weight of Group (2) is preferably no greater than 5,000, more preferably no greater than 3,000, or even more preferably no greater than 2,000. Meanwhile, from the standpoint of miscibility with a resin, the molecular weight of Group (2) is preferably no smaller than 150 or more preferably no smaller than 200.

R² in Formula (1) is a hydroxyl group, —R³, —Ar¹, —OR³, —OAr¹, —OCOR³, —OCOAr¹, —R⁴—N(R⁵)₂, or —R¹. R³ is an alkylene group that may have a substituent, Ar¹ is an aryl group that may have a substituent, R⁴ is an alkylene group that may have a substituent, and R⁵ is a hydrogen atom or an alkylene group that may have a substituent.

If R² is R¹, Compound (1) has two Groups (2). These two Groups (2) within one molecule may be identical to or different from each other. The structure of Group (2) is as described earlier.

Examples of the alkylene group that may have a substituent of R³ include those similar to the examples listed for R¹⁴ above.

Ar¹ is an aryl group that may have a substituent. The aryl group is a residue obtained by removing one hydrogen atom from a monocyclic aromatic hydrocarbon or a polycyclic aromatic hydrocarbon of two to six rings. From the standpoint of improving visible light transmittance, the aryl group is preferably a monocyclic aromatic hydrocarbon or a polycyclic aromatic hydrocarbon of two or three rings or more preferably a phenyl group or a naphthyl group. The aryl group may further have a hydrogen atom substituted. Examples of the substituent include an alkyl group of a carbon number 1-6, a halogen atom, and a hydroxyl group, and specific examples include those similar to the substituents listed for R¹¹ above.

Examples of the alkylene group that may have a substituent of R⁴ include those similar to the examples listed for R¹¹ above.

R⁵ is a hydrogen atom or an alkyl group that may have a substituent. Examples of the alkyl group that may have a substituent of R⁵ include those similar to the examples listed for R¹⁴ above.

### <Copper Ion>

The light absorbing agent of the present disclosure contains a copper ion. The copper ion is preferably supplied from a copper compound that can produce a copper ion (also referred to as a copper ion source).

For a copper ion source, a dissociative copper compound (copper salt) is preferable. Such a copper compound may include a monovalent copper ion or a divalent copper ion. In particular, a copper salt that can supply a divalent copper ion is preferable.

Examples of the copper compound include an organic salt, such as copper acetate, copper citrate, copper gluconate, copper acetate anhydrous, copper formate anhydrous, copper stearate anhydrous, copper benzoate anhydrous, copper ethylacetoacetate anhydrous, copper pyrophosphate anhydrous, copper naphthenate anhydrous, copper citrate anhydrous, or copper acetylacetonate, or a hydrate of such an organic salt; and an inorganic salt, such as copper oxide, copper chloride, copper bromide, copper iodide, copper sulfate, copper nitrate, or basic copper carbonate, or a hydrate of such an inorganic salt. These copper ion sources can each be used alone, or two or more of these copper ion sources can be used in combination.

The mole ratio of the compound expressed by Formula (1) above to the copper ion (Compound (1)/copper ion) is preferably 1/4-4/1 or more preferably 1/2-2/1.

With the mole ratio of Compound (1) to the copper ion no smaller than the lower limits above, that which has one or more Compounds (1) coordinated to a copper ion serves as a main component of the light absorbing agent. Therefore, excellent miscibility with a resin can be obtained if the mole ratio is no smaller than the lower limits above.

Although non-limiting, it has been observed that Compound (1) becomes monodentately coordinated or bidentately coordinated to a copper ion.

### <Other Ligands>

The light absorbing agent of the present disclosure may contain other ligands within a range in which advantageous effects of the present disclosure can be obtained. For such other ligands, known compounds that can be coordinated to a copper ion can be used. In particular, from the standpoint of infrared radiation absorbing performance of the light absorbing agent, the light absorbing agent preferably includes a phosphorus-based compound different from Compound (1). As such a different phosphorus-based compound, from the standpoint of infrared radiation absorbing performance, a phosphoric acid compound, such as a phosphonic acid or a phosphinic acid, is preferable.

Specific examples of the phosphoric acid include an alkyl phosphonic acid, such as ethyl phosphonic acid, propyl phosphonic acid, butyl phosphonic acid, pentyl phosphonic acid, hexyl phosphonic acid, heptyl phosphonic acid, octyl phosphonic acid, nonyl phosphonic acid, decyl phosphonic acid, undecyl phosphonic acid, dodecyl phosphonic acid, tridecyl phosphonic acid, tetradecyl phosphonic acid, pentadecyl phosphonic acid, hexadecyl phosphonic acid, heptadecyl phosphonic acid, or octadecyl phosphonic acid, phenyl phosphonic acid, phenoxy phosphonic acid, dimethyl phosphinic acid, dibutyl phosphinic acid, diphenyl phosphinic acid, diphenoxy phosphinic acid, dibutyl phosphonate, dimethyl phosphonate, and ethylene oxide-modified long chain alkyl phosphonic acid. These phosphonic acid compounds can each be used alone, or two or more of these phosphonic acid compounds can be used in combination.

From the standpoint of miscibility and infrared radiation absorbing performance, the mole ratio of the compound expressed by Formula (1) above to the other ligand above (Compound (1)/other ligand) is preferably 15-1 or more preferably 10-1.

The mole ratio of the total amount including the compound expressed by Formula (1) and ligands including the other ligand to the copper ion (ligands/copper ion) is preferably 1-6.

### [Method of Manufacturing Light Absorbing Agent]

Although there is no particular limitation on the method of manufacturing the light absorbing agent described above, with the use of the following manufacturing method, the light absorbing agent can be obtained through a simple method and at high yield. Specifically, the method of manufacturing the light absorbing agent of the present disclosure includes preparing a solution that includes a copper ion source, Compound (1) above, and a solvent and reacting a copper ion and Compound (1) above in the solution.

In the present manufacturing method, first, a copper ion source, Compound (1) above, and a solvent are prepared. Specific examples of the copper ion source are as described above, and a commercially available product or the like can be used.

Compound (1) can be synthesized, for example, according to Scheme 1 below.

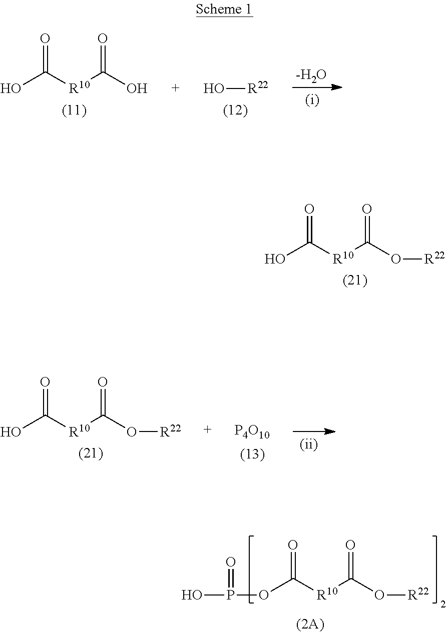

In the above, R²² corresponds to R¹³ of Compound (1).

In Scheme 1 above, dicarboxylic acid (Compound (11)) and alcohol (Compound (12)) are subjected to dehydration condensation to synthesize Compound (21) (Step (i)), and then Compound (21) and phosphorus pentoxide (Compound (13)) are reacted to obtain Compound (2A) corresponding to Compound (1) (Step (ii)). Regarding the reaction conditions at each step, reaction conditions of known dehydration condensation reactions and reactions of alcohol and phosphorus pentoxide may be referred to.

If Compound (1) in which n is no smaller than 2 is to be synthesized, Compound (12) in Scheme 1 above may be changed to dialcohol (Compound (14)) (see Scheme 2 below).

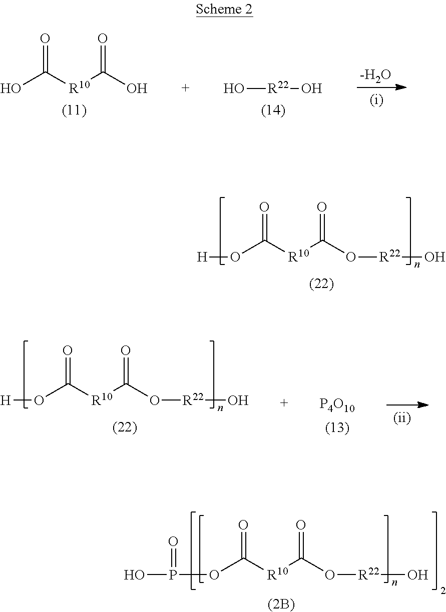

In the above, R²³ corresponds to Rig of Compound (1), and R²³OH at a terminal corresponds to R¹³ of Compound (1).

The solvent may be selected as appropriate from among solvents that can dissolve or disperse the copper ion source and Compound (1) above.

Examples of the solvent include an aromatic compound, such as benzene, toluene, or xylene; alcohols, such as methanol, ethanol, or propanol; glycol ethers, such as methyl cellosolve or ethyl cellosolve; ethers, such as diethyl ether, diisopropyl ether, or dibutyl ether; ketones, such as acetone or methyl ethyl ketone; esters, such as ethyl acetate; and a hydrocarbon-based solvent, such as hexane. These solvents may each be used alone, or a mixed solvent combining two or more of these solvents may be used. In the present manufacturing method, a mixed solvent of alcohols and an aromatic compound above is preferable. Furthermore, a cyclic ester solvent, such as γ-butyrolactone may be added.

To the solvent above, the copper ion source, Compound (1) above, and, if necessary, another ligand can be added and heated, and thus the mixture can be reacted. Although there is no particular limitation on the reaction conditions, the mixture is, for example, heated and stirred at 40-120° C. for about 1-24 hours, and thus a complex is formed. The reacted solution may be, for example, heated to remove the solvent or purified, as necessary. Through the method described above, the light absorbing agent can be manufactured suitably.

### [Composition]

A composition of the present disclosure contains the light absorbing agent described above and a resin. The use of the light absorbing agent provides a composition that excels in miscibility of the light absorbing agent and a resin and excels in dispersion stability of the light absorbing agent. Accordingly, an optical member obtained with use of this composition is a high-quality optical member in which the light absorbing agent is dispersed uniformly.

### <Resin>

A resin in the composition serves as a matrix resin in the optical member described later and can be selected as appropriate in accordance with the intended use or the like of the optical member. The resin herein may be a monomer component (matrix resin precursor), such as a curable resin.

Examples of the resin that can be used suitably in the present composition include a polyimide resin, a polyester resin, an acrylic resin, an epoxy resin, a polyurethane resin, a silicone resin, a cellulose resin, a polycarbonate resin, a polyethylene terephthalate (PET) resin, a polycarbonate resin (PC), and a cyclo olefin copolymer (COP). In particular, an acrylic resin, an epoxy resin, a silicone resin, a cellulose resin, a polyimide resin, a polycarbonate resin, or a cyclo olefin polymer is preferable. From the standpoint of higher miscibility, an acrylic resin, a silicone resin, a cellulose resin, or a polyimide resin is more preferable. Furthermore, from the standpoint of impact resistance, a polyimide resin or a cellulose resin is preferable.

From the standpoint of further improving the miscibility, the weight-average molecular weight of the resin is preferably no greater than 100,000, more preferably no greater than 50,000, or even more preferably no greater than 30,000. Although there is no particular limitation on the lower limit of the weight-average molecular weight of the resin, from the standpoint of mechanical strength and so forth of the optical member, the lower limit of the weight-average molecular weight of the resin is normally no smaller than 1,000 or preferably no smaller than 2,000.

From the standpoint of facilitating the compounding of the resin and the light absorbing agent, the present composition may further contain an organic solvent. An organic solvent may be selected as appropriate from the standpoint of its affinity with the resin.

For example, if the composition includes a polyimide resin or a polyimide precursor, a mixed solvent that includes a compound having an aromatic ring and a compound having an ester or carbonate is preferably used as an organic solvent.

Examples of the compound having an aromatic ring include benzene, toluene, xylene, and anisole. Examples of the compound having an ester or carbonate include an ester-based solvent, such as ethyl acetate, and a carbonate-based solvent, such as dimethyl carbonate. Examples of the polyimide precursor include polyamide acid.

The proportion of the light absorbing agent contained in the resin may be adjusted as appropriate in accordance with the intended use or the like of the optical member obtained. From the standpoint of achieving both dispersiveness of the light absorbing agent and infrared radiation absorbing performance of the optical member, the proportion of the light absorbing agent relative to the total amount of the composition is preferably 10-90 mass % or more preferably 30-80 mass %.

### <Other Components>

The composition of the present disclosure may contain other components within a range in which advantageous effects of the present disclosure can be obtained. Examples of such other components that can be included in the present composition include an antioxidant and a surfactant.

An antioxidant can be selected as appropriate from among known antioxidants. Specific examples include a hindered phenol-based antioxidant, a hindered amine-based antioxidant, a phosphorus-based antioxidant, and a sulfur-based antioxidant.

Examples of the surfactant include an anionic surfactant, a cationic surfactant, a nonionic surfactant, and an amphoteric surfactant. From the standpoint of miscibility with the light absorbing agent above of the present disclosure, a phosphate ester-type anionic surfactant is preferable.

The method of preparing the composition described above may be any method that allows the light absorbing agent to be dispersed uniformly in the resin and may be selected as appropriate from among known methods. In one example, the present composition of varnish form can be obtained by dispersing the light absorbing agent in an organic solvent, adding a varnish-form resin into the solution, stirring the mixture uniformly with any of various stirring devices, and removing the solvent as necessary.

### [Optical Member]

The optical member of the present disclosure is a molded body in which the light absorbing agent described above is dispersed in a matrix resin.

In the present optical member, the light absorbing agent above and the matrix resin are highly compatible and are dispersed uniformly. Therefore, the optical member can suppress haze and excels in optical performance.

The matrix resin is the resin in the composition described above, and if the resin in the composition is a precursor, the present matrix resin represents a resin obtained through a reaction of the precursor. For example, if the resin is a polyimide precursor, the present matrix resin is a polyimide resin.

The shape of the present optical member may be designed as appropriate in accordance with its intended use or the like. For example, the optical member may have a lens shape of, for example, a convex lens or a concave lens; a prism shape; a sheet-like shape having micro concavities and convexities, such as a prism sheet or a Fresnel lens; or a film-like shape consisting of flat surfaces.

The method of manufacturing the optical member may be selected as appropriate in accordance with the shape or the like of the optical member. For example, if the optical member is a lens or a prism, various molding methods, such as an injection molding method, can be used. A flat film-like optical member can be obtained, for example, by applying the composition above of varnish form to a substrate to form a flat coating, drying the coating, and allowing for a curing reaction as necessary. A sheet-like optical member having micro concavities and convexities can be obtained, for example, by shaping the coating above with a mold or the like.

Since the present optical member has excellent optical characteristics, the present optical member can be used suitably as a near-infrared radiation absorbing film disposed on a light receiving surface of an image sensor, such as a CCD or a CMOS. Furthermore, since the present optical member excels in infrared radiation absorbing performance and has high visible light transmittance, the present optical member can be used suitably also as a member that absorbs heat rays. Since an optical member that includes a polyimide resin as the resin excels in mechanical strength or heat resistance, such an optical member can be used suitably for the intended uses mentioned above.

### EXAMPLES

The present disclosure will be described specifically based on examples and comparative examples below. These examples, however, do not limit the present disclosure.

### Example 1: Manufacture of Light Absorbing Agent, Composition, and Optical Member

1.56 g of copper acetate monohydrate (Wako Pure Chemical Ltd.) was dissolved in a mixed solvent of 75 g of 1 propanol and 75 g of toluene, and the resultant was stirred at normal temperature to prepare a solution a. Into this solution, 17.5 g of Compound (a) below was added and dissolved, and then 8.2 g of γ butyrolactone was added. After the resultant was heated and stirred at 100° C. for 3 hours, a portion of the solvent was removed, and 14.5 g of a light absorbing agent solution was obtained.

1.8 g of this light absorbing agent solution was added to 0.58 g of a liquid polyimide resin (SPIXAREA VR0161 manufactured by SOMAR Corp.), and the mixture was stirred at normal temperature for 30 minutes to obtain 2.38 g of a light absorbing agent-containing composition.

1.9 g of this near-infrared radiation absorbing agent-containing resin was applied onto a glass substrate and heated at 100° C. for 24 hours in a firing furnace to obtain an optical member (infrared radiation absorbing film) having a thickness of 0.43 mm.

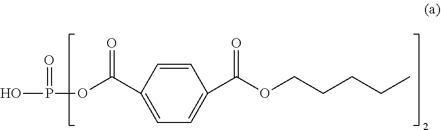

### Examples 2-8: Manufacture of Light Absorbing Agent, Composition, and Optical Member

Light absorbing agents, compositions, and optical members of Examples 2-8 were obtained in a similar manner to Example 1 except that, in place of Compound (a) of Example 1, mixtures of Compound (a) and Compounds (b) to (h) below (their mole ratios are shown in Table 1) were used.
Compound (b): butyl phosphonic acid (CH₃(CH₂)₃—P(═O)(—OH)₂)
Compound (c): dibutyl phosphate ([CH₃(CH₂)₃O—]₂P(═O)(—OH))
Compound (d): phenyl phosphonic acid (Ph-P(═O)(—OH)₂)
Compound (e): diphenyl phosphinic acid ((Ph-)₂P(═O)(—OH))
Compound (f): phenyl phosphate (PhO—P(═O)(—OH)₂)
Compound (g): diphenyl phosphate ((PhO—)₂P(═O)(—OH))
Compound (h): ethyl phosphonic acid (CH₃CH₂—P(═O)(—OH)₂)

### Examples 9-16: Manufacture of Light Absorbing Agent and Optical Member

Light absorbing agents, compositions, and optical members of Examples 9-16 were obtained in a similar manner to Example 1 except that, in place of Compound (a) of Example 1, Compounds (b) to (i) were used.
Compound (i): (C₁₅H₃₁(OCH₂CH₂)₆O—P(═O)(—OH)₂)

### Example 17: Manufacture of Light Absorbing Agent and Optical Member

A light absorbing agent, a composition, and an optical member of Example 17 were obtained in a similar manner to Example 1 except that, in place of Compound (a) of Example 1, a mixture of Compound (h) and Compound (i) (the mole ratio is shown in Table 1) was used.

### Examples 18-21: Manufacture of Light Absorbing Agent and Optical Member

Light absorbing agents, compositions, and optical members of Examples 18-21 were obtained in a similar manner to Examples 1, 4, 11, and 17, respectively, except that, in place of the liquid polyimide resin of Examples 1, 4, 11, and 17, a cellulose (CAP-504-0.2, manufactured by Eastman Chemical) solution was used.

### <Spectrometry>

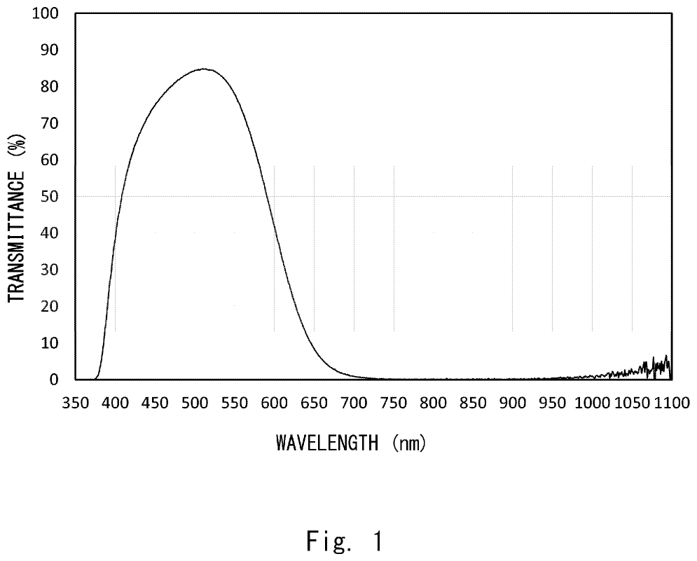

The spectral transmittance of the optical members obtained in the examples above was measured. The transmittances at a wavelength of 500 nm and at a wavelength of 800 nm are shown in Table 1. The transmittance spectrum of Example 1 is shown in FIG. 1.

TABLE 1

| | Phosphorus | Phosphorus | | | | | |
|---|---|---|---|---|---|---|---|
| | compound | compound | Mole ratio | | Transmittances(%) | Transmittances(%) | |
| No. | (A) | (B) | (A)/(B) | Resin | at 500 nm | at 800 nm | Note |
| 1 | (a) | — | — | Polyimide | 83.9 | 0.6 | Example |
| 2 | (a) | (b) | 7.2 | Polyimide | 84.5 | 0.1 | Example |
| 3 | (a) | (c) | 4.0 | Polyimide | 83.3 | 0.2 | Example |
| 4 | (a) | (d) | 8.8 | Polyimide | 80.1 | 0.1 | Example |
| 5 | (a) | (e) | 9.2 | Polyimide | 84.9 | 0.1 | Example |
| 6 | (a) | (f) | 8.5 | Polyimide | 83.2 | 0.5 | Example |
| 7 | (a) | (g) | 4.2 | Polyimide | 80.1 | 0.7 | Example |
| 8 | (a) | (h) | 4.5 | Polyimide | 79.6 | 0.2 | Example |
| 9 | (b) | — | — | Polyimide | 12.1 | 0.1 | Comparative Example |
| 10 | (c) | — | — | Polyimide | 5.3 | 0.5 | Comparative Example |
| 11 | (d) | — | — | Polyimide | 8.1 | 0.2 | Comparative Example |
| 12 | (e) | — | — | Polyimide | 6.7 | 0.1 | Comparative Example |
| 13 | (f) | — | — | Polyimide | 26.3 | 0.1 | Comparative Example |
| 14 | (g) | — | — | Polyimide | 45.3 | 0.3 | Comparative Example |
| 15 | (h) | — | — | Polyimide | 32.1 | 0.1 | Comparative Example |
| 16 | (i) | — | — | Polyimide | 12.2 | 0.2 | Comparative Example |
| 17 | (h) | (i) | 4.5 | Polyimide | 4.7 | 0.3 | Comparative Example |
| 18 | (a) | — | — | Cellulose | 86.3 | 0.4 | Example |
| 19 | (a) | (d) | 8.8 | Cellulose | 86.1 | 0.1 | Example |
| 20 | (d) | — | — | Cellulose | 21.8 | 0.8 | Comparative Example |
| 21 | (h) | (i) | 4.5 | Cellulose | 9.7 | 0.3 | Comparative Example |

As shown in Table 1, the optical members of Examples 1 to 21 all have a low transmittance to light at a wavelength of 800 nm, and this indicates that their performance of blocking infrared radiation is high. Meanwhile, a comparison between Examples 1-8 and Examples 9-17 shows a difference in their transmittance to light at a wavelength of 800 nm (visible light). In the optical members of Examples 1-8, in which a light absorbing agent that contains Compound (a) corresponding to the compound expressed by Formula (1) is used, the light absorbing agent and the resin are highly compatible, and haze is suppressed. As a result, optical members that excel in visible light transmitting performance are obtained. In contrast, haze occurs in Examples 9-17, which do not include the compound expressed by Formula (1), and a low visible light transmittance is observed. Similar results are obtained in Examples 18-21, in which the resin is changed to cellulose.

In this manner, the light absorbing agent of the present embodiment, which contains a compound expressed by Formula (1) and a copper ion, excels in miscibility with a resin, and an optical member that excels in visible light transmitting performance and near-infrared radiation blocking performance can be obtained.

The present disclosure is not limited by the foregoing embodiments, and modifications can be made as appropriate within the scope that does not depart from the technical scope and spirit.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A light absorbing agent comprising:
a compound expressed by Formula (1) below; and
a copper ion, 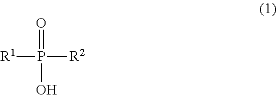
wherein
R¹ is a group expressed by Formula (2) below,
R² is a hydroxyl group, —R³, —Ar¹, —OR³, —OAr¹, —OR⁴—Ar¹, —OCOR³, —OCOAr¹, —R⁴—N(R⁵)₂, or —R¹,
R³ is an alkyl group that may have a substituent,
Ar¹ is an aryl group that may have a substituent,
R⁴ is an alkylene group that may have a substituent,
R⁵ is a hydrogen atom or an alkyl group that may have a substituent, 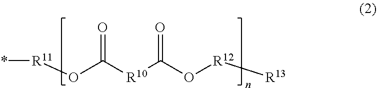
R¹⁰ is an alkylene group or arylene group that may have a substituent,
R¹¹ is a single bond or an alkylene group that may have a substituent,
R¹² is an alkylene group or arylene group that may have a substituent, wherein R¹² that bonds to R H is a single bond,
R¹³ is a hydrogen atom or —R¹⁴ or —R¹⁵OH,
R¹⁴ is an alkyl group that may have a substituent,
R¹⁵ is a single bond or an alkylene group that may have a substituent,
n is an integer no smaller than 1,
* is a bond that bonds to P, and
if a formula includes multiple identical symbols, the multiple identical symbols may be groups identical to or different from each other.

2. The light absorbing agent according to claim 1, wherein the group expressed by Formula (2) has a molecular weight of no greater than 5,000.

3. The light absorbing agent according to claim 1, wherein a mole ratio of the compound expressed by Formula (1) to the copper ion is 1/4-4/1.

4. The light absorbing agent according to claim 1, wherein n is 1.

5. A composition comprising:
the light absorbing agent according to claim 1; and
a resin.

6. The composition according to claim 5, wherein the resin is an acrylic resin, an epoxy resin, a silicone resin, a cellulose resin, a polyimide resin, a polycarbonate resin, a cyclo olefin polymer, or a precursor thereof.

7. The composition according to claim 6, wherein the resin has a weight-average molecular weight of no greater than 100,000.

8. The composition according to claim 6, further comprising an organic solvent.

9. An optical member, comprising
the light absorbing agent according to claim 1 dispersed in a matrix resin.

10. A method of manufacturing the light absorbing agent according to claim 1, the method comprising:
preparing a solution that includes a copper ion source, a compound expressed by Formula (1) below, and a solvent; and
reacting the copper ion and the compound expressed by Formula (1) below in the solution, 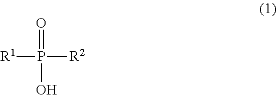
wherein
R¹ is a group expressed by Formula (2) below,
R² is a hydroxyl group, —R³, —Ar¹, —OR³, —OAr¹, —OR⁴—Ar¹, —OCOR³, —OCOAr¹, —R⁴—N(R⁵)₂, or —R¹,
R³ is an alkyl group that may have a substituent,
Ar¹ is an aryl group that may have a substituent,
R⁴ is an alkylene group that may have a substituent,
R⁵ is a hydrogen atom or an alkyl group that may have a substituent, 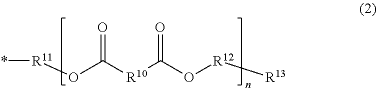
R¹⁰ is an alkylene group or arylene group that may have a substituent,
R¹¹ is a single bond or an alkylene group that may have a substituent,
R¹² is an alkylene group or arylene group that may have a substituent, wherein R¹² that bonds to R¹³ is a single bond,
R¹³ is a hydrogen atom or —R¹⁴ or —R¹⁵OH,
R¹⁴ is an alkyl group that may have a substituent,
R¹⁵ is a single bond or an alkylene group that may have a substituent,
n is an integer no smaller than 1,
* is a bond that bonds to P, and
if a formula includes multiple identical symbols, the multiple identical symbols may be groups identical to or different from each other.
